(19) United States
(12) Patent Application Publication
(10) Pub. No.: US 2005/0063567 A1
(43) Pub. Date: Mar. 24, 2005

(54) Authentication apparatus and authentication method

(75) Inventors: Hirofumi Saitoh, Ogaki-city (JP); Tatsushi Ohyama, Ogaki-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/945,901

(22) Filed: Sep. 22, 2004

(30) Foreign Application Priority Data
Sep. 24, 2003 (JP) 2003-332498

(51) Int. Cl. G06K 9/00

(52) U.S. Cl. 382/115

(57) ABSTRACT

In an authentication input apparatus, an input unit is a surface for inputting data of an input device such as a pressure sensitive sensor. The input device may also be an optical sensor such as a CCD. The input unit receives from a user input of a fingerprint, a signature or the like. In inputting the signature, the input unit functions as a tablet for inputting signatures utilizing a stylus equipment or the like. In inputting the fingerprint or the signature the user specifies the type of authentication information to be inputted by pressing a fingerprint selection button or a signature selection button. Fingerprint data are obtained by the input device when the user puts the finger on the input unit after pressing the fingerprint selection button. Signature data are obtained by the input device when the user signs on the input unit 10 after pressing the signature selection button.

### BACKGROUND OF THE INVENTION

1. Field of the Invention

The present invention relates to an authentication technology, and it particularly relates to an authentication apparatus and an authentication method for implementing individual authentication using biometric data and other data.

2. Description of the Related Art

A material belonging to a person such as a magnetic card or an IC card, or secret information allotted to the person such as a password or a security code number has been utilized individual authentication. Nowadays, biometric data have alternatively come to be utilized in the individual authentication. The biometric data to be utilized in such biometric authentication are, for example, information showing the bodily features of a person such as a fingerprint, a palm print, a face, an iris or voiceprint. As another example, feature in a person's behavior can also be the biometric data, such as a signature or a gesture of the person.

It is often the case that the biometric authentication can not be carried out enough accurately based only on one type of the biometric data. In another case, the biometric data of that type can not be obtained or extracted from a person because of his/her physical defection or the like. Therefore, a combined type authentication technology is being developed, where biometric data of more than two types are utilized for individual authentication (For example, refer to the related art list: [1]). By utilizing the biometric data of more than two types in the biometric authentication, authentication accuracy can be increased than the authentication by biometric data of a single kind. Therefore, this combined type biometric authentication method can be implemented for practical use while it has been difficult to utilize practically the biometric authentication based on only information of one kind because of its inaccuracy.

Related Art List

[1] Japanese Patent Application Laid-Open No. 2003-30154

In a system or apparatus for the combined type authentication, however, different input devices are respectively provided therein for each biometric data type. Accordingly, the entire size of such system or apparatus inevitably becomes larger and the manufacturing cost thereof becomes high. Moreover, such system or apparatus is not sufficiently convenient for users, as the users have to input their biometric data via several input devices.

### SUMMARY OF THE INVENTION

The present invention has been made in view of foregoing circumstances, and an object thereof is to provide an authentication technology where the structure of a combined type authentication system can be simplified and manufacturing cost thereof can be reduced.

A preferred embodiment according to the present invention relates to an authentication apparatus. This apparatus includes a single input device, wherein biometric data of two or more types are sequentially inputted to the single input device. The biometric data are not inputted to the single input device all at once, but are inputted thereto sequentially from one type after another. The biometric data comprise information showing the bodily feature of a person, such as a fingerprint, a palm print, a face, an iris, a retina, vein or voiceprint. The biometric information may also comprise information showing features in the person's behavior, such as a signature or a gesture. According to the apparatus of the present invention, the single input unit can be commonly used for inputting the biometric data of two or more kinds.

Another preferred embodiment of the present invention also relates to an authentication apparatus. This apparatus comprises a single input device to which biometric data and non-biometric data are inputted, wherein the biometric data and the non-biometric data are inputted thereto sequentially. The non-biometric data comprise secret information allotted to a person such as a password or a security code number. According to the apparatus of the present invention, the input device for the biometric data can also be utilized for inputting the non-biometric data.

Another preferred embodiment of the present invention relates to an authentication method. This method comprises: receiving input of information for authentication of more than two types by a single input device; and receiving from a user information specifying a type of the information to be inputted when the information is inputted.

Another preferred embodiment of the present invention also relates to an authentication method. This method comprises: receiving input of information for authentication of more than two types by a single input device; and detecting a type of the inputted information for the authentication among precedently assumed types.

Moreover, any arbitrary replacement or substitution of the above-described structural components and the steps, expressions replaced or substituted in part or whole between a method and an apparatus as well as addition thereof, and expressions changed to a system, a computer program, a storage medium, a transmission medium or the like are all effective as and are encompassed by the present invention.

This summary of the invention does not necessarily describe all necessary features, so that the invention may also be a sub-combination of these described features.

### BRIEF DESCRIPTION OF THE DRAWINGS

FIG. 1 is a diagram showing an external view of an authentication input apparatus according to the first embodiment of the present invention.

FIG. 2 is a diagram showing an external view of another authentication input apparatus according to the first embodiment of the present invention.

FIG. 3 is a diagram showing an external view of yet another authentication input apparatus according to the first embodiment of the present invention.

FIG. 4 is a diagram showing an external view of yet another authentication input apparatus according to the first embodiment of the present invention.

FIG. 5 is a diagram showing an external view of yet another authentication input apparatus according to the first embodiment of the present invention.

FIGS. 6A and 6B show manners of inputting authentication information to the authentication input apparatus shown in FIG. 5.

FIG. 7 is a diagram showing an external view of yet another authentication input apparatus according to the first embodiment of the present invention.

FIG. 8 is a diagram showing a structure of an authentication system according to the first embodiment of the present invention.

FIG. 9 is a flow chart showing an authentication procedure by the authentication system shown in FIG. 8.

FIG. 10 is a diagram showing an external view of an authentication input apparatus according to a second embodiment of the present invention.

FIG. 11 is a diagram showing a structure of an authentication system according to the second embodiment of the present invention.

FIG. 12 is a flow chart showing an authentication procedure by the authentication system shown in FIG. 11.

### DETAILED DESCRIPTION OF THE INVENTION

The invention will now be described by reference to the preferred embodiments. This does not intend to limit the scope of the present invention, but to exemplify the invention.

First Embodiment

Hereunder will be described an authentication system according to the first embodiment of the present invention. The authentication system comprises an input apparatus for authentication (hereinafter referred to as “authentication input apparatus”) which receives from a user the input of information to be utilized in the authentication (hereinafter referred to as “authentication information”) and a processing apparatus for the authentication (hereinafter referred to as “authentication processing apparatus”) which performs the authentication of the user based on the authentication information being inputted to the authentication input apparatus.

The authentication input apparatus according to the first embodiment of the present invention comprises a single input device for a user to input the authentication information and an authentication type selector for a user to selectively specify the type of authentication information. Hereunder will be described various types of the authentication input apparatus according to the first embodiment of the present invention.

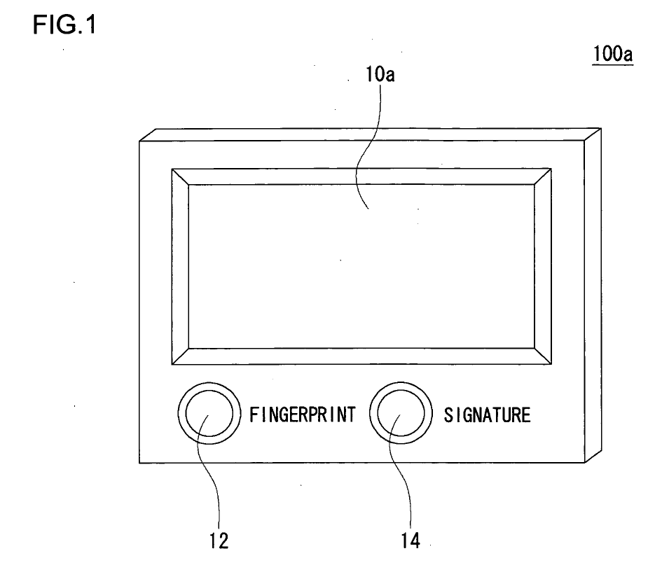

FIG. 1 is a drawing showing the external view of an authentication input apparatus 100a. An input unit 10a is a surface of an input device for inputting data, which is structured with a pressure sensitive sensor or an optical sensor such as CCD (Charge-Coupled Device). The input unit 10a receives from a user the input of a fingerprint and a signature. In inputting the signature, the input unit 10a functions as a tablet for inputting signatures utilizing a stylus equipment or the like.

A fingerprint selection button 12 and a signature selection button 14 are buttons for the user to selectively specify the kind of authentication information to be inputted. Fingerprint data are obtained when the user puts his/her finger on the input unit 10a after pressing the fingerprint selection button 12. On the other hand, signature data are obtained when the user signs on the input unit 10a after pressing the signature selection button 14.

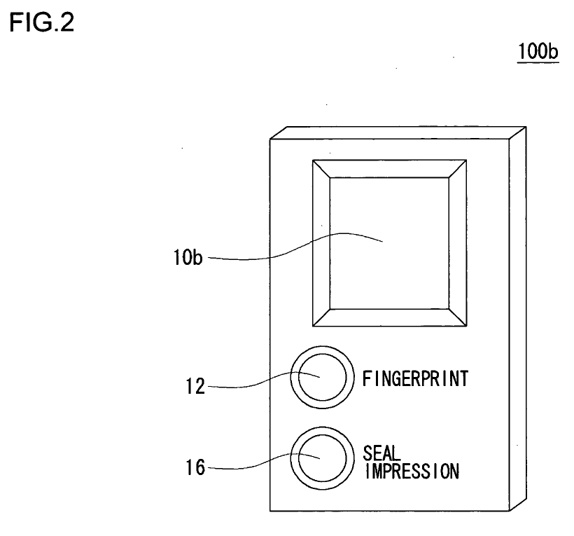

FIG. 2 is a drawing showing the external view of another authentication input apparatus 100b. An input unit 10b is a surface of an input device structured by a pressure sensitive sensor, an optical sensor or the like. The input unit 10b receives the fingerprint and seal impression of a user. The input unit 10b functions as a plate for inputting seal impressions when the user inputs his/her seal impression as authentication information. Fingerprint data are obtained when the user put his/her finger on the input unit 10b after pushing a fingerprint selection button 12. On the other hand, seal impression data are obtained when the user puts his/her seal impression after pushing a seal impression selection button 16.

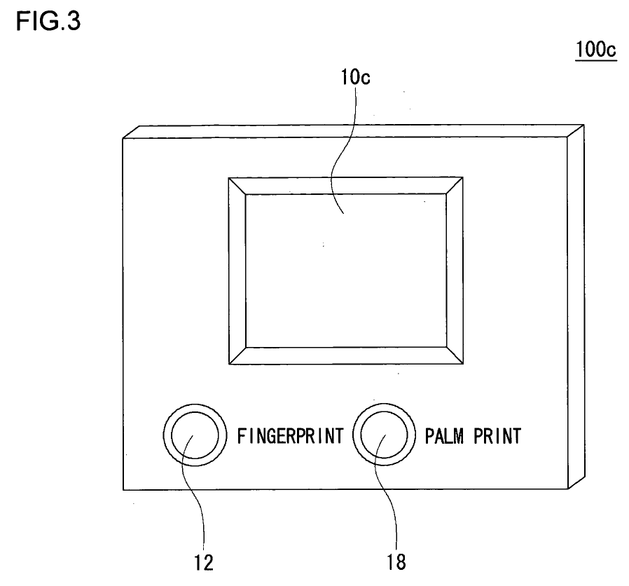

FIG. 3 is a drawing showing the external view of yet another authentication input apparatus 100c. An input unit 10c is a surface of an input device structured by a pressure sensitive sensor, an optical sensor or the like. The input unit 10c receives the fingerprint and palm print inputted by a user. The input unit 10c is made as large as a human palm. Fingerprint data are obtained when the user puts his/her finger on the input unit 10c after pressing a fingerprint selection button 12. On the other hand, palm print data are obtained when the user puts his/her palm after pressing a palm print selection button 18.

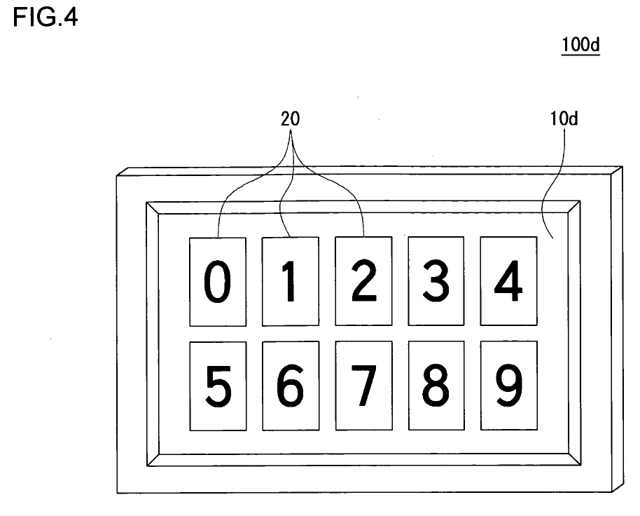

FIG. 4 is a drawing showing the external view of yet another authentication input apparatus 100d. An input unit 10d is a surface of an input device structured by a pressure sensitive sensor, an optical sensor or the like. The input unit 10d receives the fingerprint and secret code number inputted by a user. The input unit 10d can function as a touch panel for inputting secret code numbers. A user can input the secret code number by pushing ten-key 20 (Here, ten-key is, for example, numeric characters indicated on the surface of the input unit 10d). The fingerprint of the user is obtained when the user presses the ten-key 20.

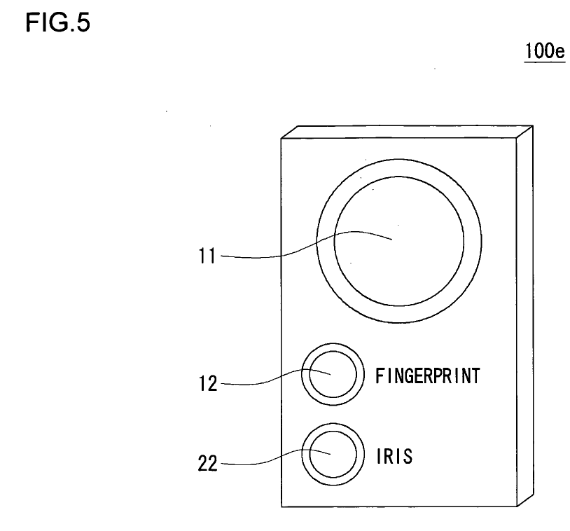

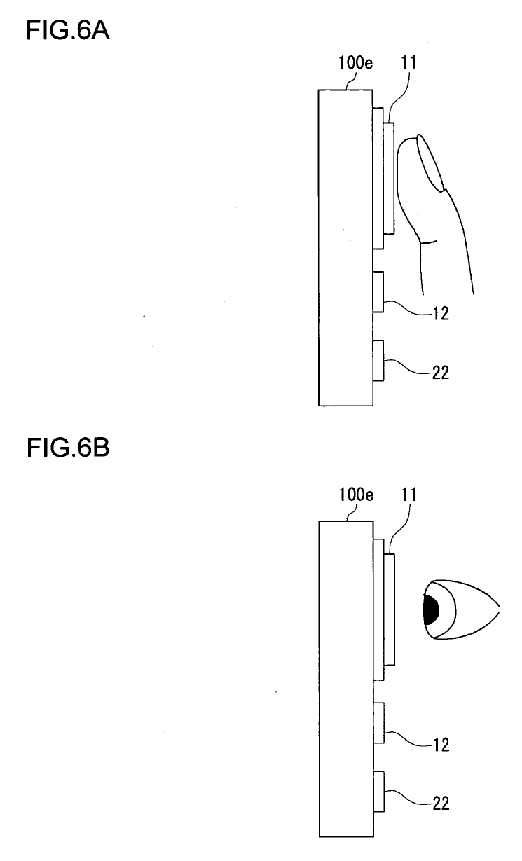

FIG. 5 is a drawing showing the external view of yet another authentication input apparatus 100e. An image input unit 11 is a surface of an input device for inputting authentication information, which is structured by an optical sensor or the like. The image input unit 11 receives the fingerprint and iris image inputted by a user. Fingerprint data are obtained when the user puts his/her finger on the image input unit 11 as shown in FIG. 6A, after pushing a fingerprint selection button 12. On the other hand, the iris image is obtained when the user brings his/her eye near to the image input unit 11 as shown in FIG. 6B, after pushing an iris image selection button 22.

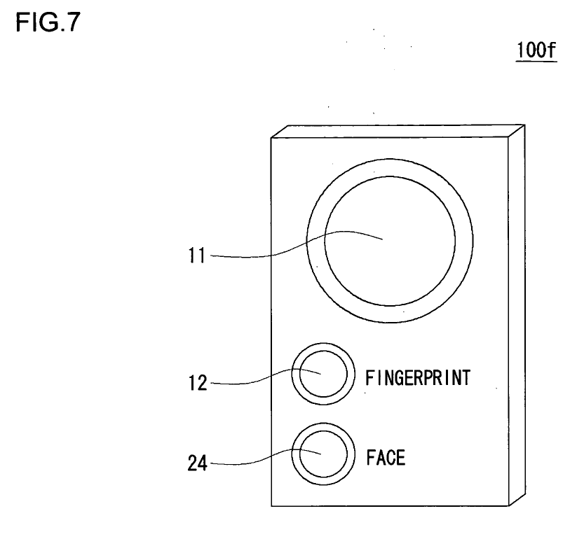

FIG. 7 is a drawing showing the external view of yet another authentication input apparatus 100f. An image input unit 11 is a surface of an input device for inputting authentication information, which is structured by an optical sensor or the like. The image input unit 11 receives the fingerprint and face image inputted by a user. Fingerprint data are obtained when the user puts his/her finger on the image input unit 11 after pushing a fingerprint selection button 12. On the other hand, the face image is obtained by the image input unit 11 when the user pushes a face image selection button 24.

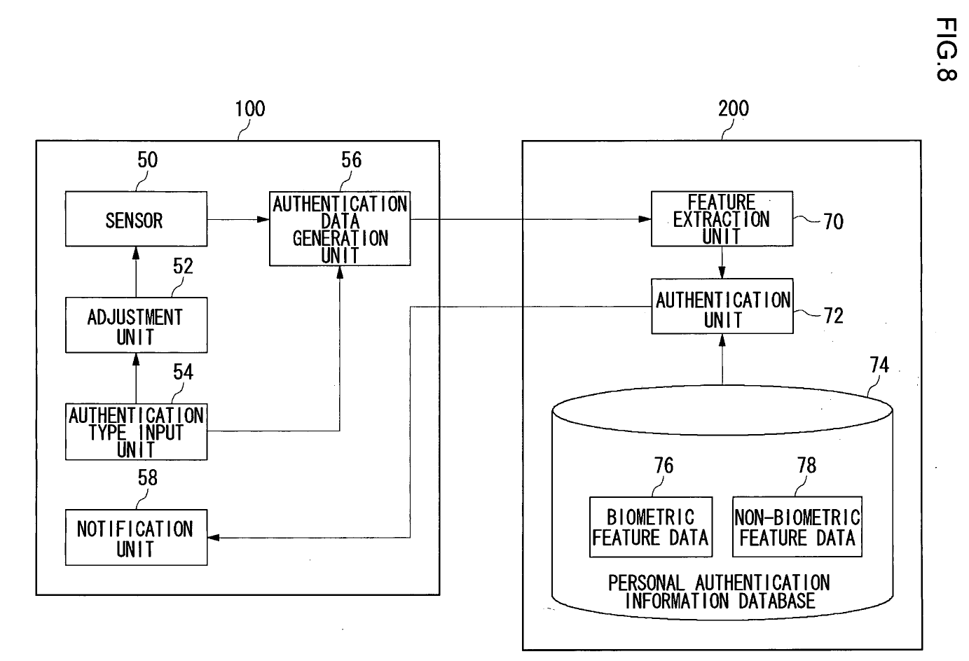

FIG. 8 shows the structure of the authentication system according to this embodiment of the present invention. The authentication system may comprise any one of the authentication input apparatuses 100a to 100f described above and also comprises an authentication processing apparatus 200. Hereafter, the authentication apparatuses 100a to 100f are named generically as an authentication input apparatus 100. The authentication apparatus 100 comprises a sensor 50, an adjustment unit 52, an authentication type input unit 54, an authentication data generation unit 56 and a notification unit 58. The authentication processing apparatus 200 comprises a feature extraction unit 70, an authentication unit 72 and a personal authentication information database 74. In terms of hardware components, the above described system is usually realized mainly by a CPU, a memory and another LSI. On the other hand, the system can be realized by a program having a function of authentication processing, which is loaded in a memory. It is to be noted that FIG. 8 simply shows a function-oriented block diagram. It is to be understood by those skilled in the art that these function-oriented block can be realized only by hardware or software or by combination thereof.

The authentication input apparatus 100 and the authentication processing apparatus 200 may be connected by a connection cable or the like or may be connected via a network. In another configuration, the authentication input apparatus 100 and the authentication processing apparatus 200 can be structured integrally as a single authentication apparatus. The feature extraction unit 70 and the authentication unit 72 may not be provided in the authentication processing unit 200 but may be provided in the authentication input unit 100. In this case, the authentication input apparatus 100 retrieves the personal authentication information database 74 through a connection cable or a network.

The sensor 50 is a pressure sensitive sensor or an optical sensor, which receives the authentication information presented by the user. When the user inputs the authentication information, the user selectively specifies the type of authentication information to be inputted by the action of pushing a button or the like. The authentication type input unit 54 receives the specified type of authentication information. The adjustment unit 52 adjusts the sensor 50's parameter and so forth based on the type of the authentication information obtained by the authentication type input unit 54. The adjustment unit 52, for example, adjusts the sensitivity of the pressure sensitive sensor or the focal distance of a lens in a CCD camera unit in accordance with the type of the authentication information. The authentication data generation unit 56 processes signals obtained by the sensor 50 and generates authentication data. Then the authentication data generation unit 56 transmits the authentication data to the authentication processing apparatus 200 with identification information which indicates the type of authentication information obtained by the authentication type input unit 54.

As components of an authentication processing unit, the authentication processing apparatus 200 is provided with the feature extraction unit 70 and the authentication unit 72. The feature extraction unit 70 extracts a feature necessary for the authentication from the authentication data provided by the authentication input apparatus 100. The extraction of the features is carried out by applying image processing or another analysis method suitable for the type of the authentication information, which is determined based on the identification information showing the type of the authentication information. The authentication unit 72 performs the authentication by comparing the data of extracted feature to feature data of the user precedently registered in the personal authentication information database 74. The personal authentication information database 74 comprises biometric feature data 76 and non-biometric feature data 78. The biometric feature data 76 are data of the bodily features of users or the features in behaviors of users, such as a fingerprint, an iris, handwriting or the like. The non-biometric data 78 are data of secret information such as a password, a security code number and so forth. The authentication unit 72 carries out a retrieval on the biometric data 76 or the non-biometric data 78 in accordance with the identification information showing the type of the authentication information. Then the extracted feature data of the user are compared therewith.

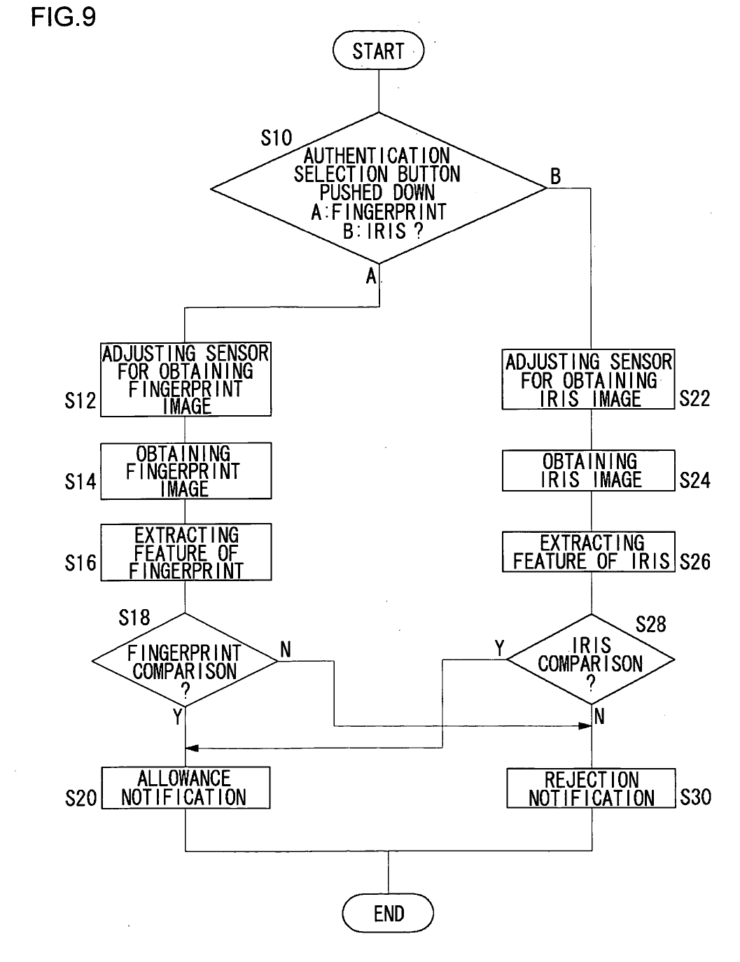

FIG. 9 is a flowchart showing the authentication procedure in the authentication system according to the first embodiment. Hereunder will be described as an example the authentication procedure of the authentication system having the authentication input unit 100e shown in FIG. 5.

The authentication type input unit 54 in the authentication input apparatus 100 receives the action of pushing down the authentication selection button by the user (S10). The case where the user pushes the fingerprint selection button 12 (A in S10) will hereunder be described first. The adjustment unit 52 adjusts the sensor 50 for obtaining the fingerprint of the user (S12). The user puts his/her finger on the surface of the image input unit 11 when inputting the fingerprint as the authentication information. Accordingly, the adjustment unit 52 adjusts the lens of the CCD camera unit in the sensor 50 so that the focus thereof might be put on the surface of the image input unit 11. Then the fingerprint image is obtained by the sensor 50 (S14). The authentication data generation unit 56 obtains identification information from the authentication type input unit 54 and adds it to the fingerprint image obtained in the sensor 50, the identification information indicating that the type of the authentication information is the fingerprint. Then the authentication data generation unit 56 sends the fingerprint image with the identification information to the feature extraction unit 70 in the authentication processing apparatus 200. As the identification information shows that the type of the authentication information is the fingerprint, the feature extraction unit 70 carries out image processing suitable for fingerprint image on the fingerprint image sent from the authentication data generation unit 56 and then extracts the feature in the fingerprint (S16).

The authentication unit 72 retrieves the biometric feature data 76 of registered users, which are stored in the personal authentication information database 74. The authentication unit 72 then compares the feature in the fingerprint of the user extracted by the feature extraction unit 70 with the features in the fingerprints of registered users for examining if there is a fingerprint having the feature identical with that of the user in the biometric feature data 76 (S18). When it is determined that the fingerprint of the user is the fingerprint of one of the registered users (Y in S18), the notification unit 58 presents an allowance notification to the user by a buzzer, a light or the like (S20). When there is no fingerprint identical with the user's fingerprint found among the fingerprints of the registered users (N in S18), the notification unit 58 presents a rejection notification to the user (S30).

Descriptions will be made next on a case that the iris selection button 22 is pressed by the user (B in S10). The adjustment unit 52 adjusts the sensor 50 for carrying out the authentication by an iris (S22). The user brings his/her eye close to the image input unit 11 of the authentication input apparatus 100 for inputting the iris. The distance between the eye and the image input unit 11 varies on a case-by-case basis. Thus the adjustment unit 52 adjusts the focal distance of the lens of the CCD camera unit in the sensor 50 in an auto focusing manner. The sensor 50 obtains the iris image (S24). The authentication data generation unit 56 obtains identification information from the authentication type input unit 54 and adds it to the iris image obtained in the sensor 50, the identification information indicating that the type of the authentication information is the iris. Then the authentication data generation unit 56 sends the iris image with the identification information to the feature extraction unit 70 in the authentication processing apparatus 200. As the identification information shows that the type of the authentication information is the iris, the feature extraction unit 70 carries out image processing suitable for iris images on the iris image sent from the authentication data generation unit 56 and then extracts the feature in the iris (S26).

The authentication unit 72 retrieves the biometric feature data 76 of the registered users, which are stored in the personal authentication information database 74. The authentication unit 72 then compares the feature in the iris of the user extracted by the feature extraction unit 70 with the features in the irises of the registered users for examining if there is an iris having the feature identical with that of the user in the biometric feature data 76 (S28). When it is determined that the iris of the user is the iris of one of the registered users (Y in S28), the notification unit 58 presents the allowance notification to the user by a buzzer, a light or the like (S20). When there is no iris identical with the user's iris found among the irises of the registered users (N in S28), the notification unit 58 presents a rejection notification to the user (S30).

According to the authentication procedure described above, the authentication of the user is carried out based on the fingerprint or the iris. Accordingly, even in a case that one type of the biometric data can not be presented for the authentication because of the user's particular circumstance, the authentication of the user can be carried out based on the other type of the biometric data. In another example, the authentication of the user may be carried out based on both types of the biometric data. In that case, the accuracy of the authentication can be increased because of the combination of the fingerprint authentication and the iris authentication.

With the authentication input apparatus 100 according to the first embodiment of the present invention, the authentication information of two or more kinds can be input into the single input device one kind after another. The authentication information of two or more kinds may be the biometric data of two or more types, such as a fingerprint, a palm print, an iris and so forth. In another case, the authentication information may be the combination of the biometric data and the non-biometric data such as a security code number. Generally, in inputting authentication information of two or more kinds, an input device dedicated for inputting one type of authentication information and another input device dedicated for inputting another type of authentication information are used respectively. On the other hand, according to the first embodiment of the present invention, the single input device is used commonly for inputting different kinds of authentication information. Thus the size of the apparatus can be made small. Also, cost for manufacturing the apparatus can be reduced.

Moreover, in the authentication system according to the first embodiment of the present invention, the accuracy of the authentication can be enhanced because of the combination of biometric authentication of two or more kinds or because of the combination of the biometric authentication and the non-biometric authentication. For a particular user, one type of biometric authentication can not be carried out because of the user's circumstance. The authentication system of the first embodiment can perform the authentication in such a case. Therefore, this authentication system can be utilized in various manners or fields.

Moreover, according to the first embodiment of the present invention, a user inputs the type of authentication information to be utilized for the authentication in inputting the authentication information to the single input device, therefore the authentication system can properly performs the authentication processing corresponding to the type of authentication information being inputted without detecting the type thereof by itself.

Second Embodiment

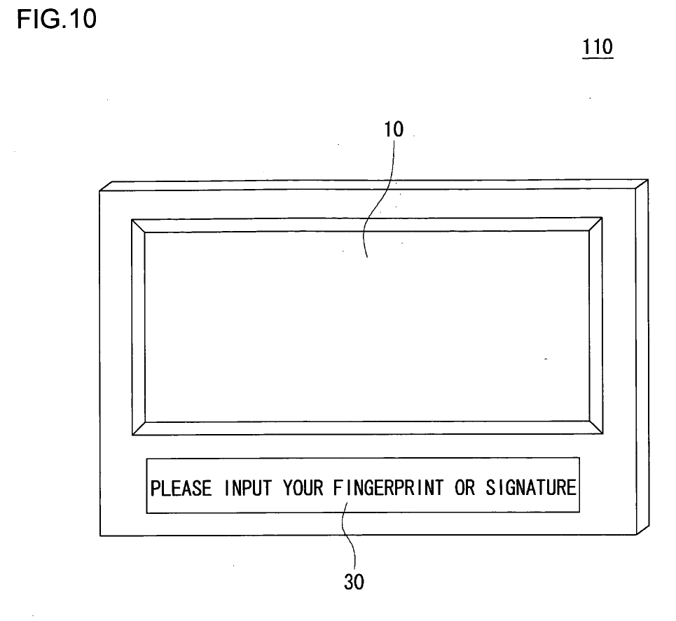

FIG. 10 shows the external view of an authentication input apparatus 110 according to the second embodiment of the present invention. The authentication input apparatus 110 according to the second embodiment differs from the authentication input apparatus 100 of the first embodiment in a point that the authentication input apparatus 110 is not provided with buttons for a user to specify the types of authentication information. In stead thereof, the authentication input apparatus 110 comprises a display 30 for instructing the user to input authentication information of precedently assumed types. By replacing the buttons for selecting the type of authentication information shown in the authentication input apparatuses 100a to 100f according to the first embodiment with the display 30, the authentication input apparatus 110 can be configured to various types in correspondence with the types of the authentication input apparatus 100. The type of the authentication input apparatus 110 in FIG. 10 corresponds to that of the authentication input apparatus 10a shown in FIG. 1, which is acquired by replacing the buttons for selecting the authentication information in the authentication input apparatus 100a with the display 30. Hereunder description of the second embodiment will be made regarding the authentication input apparatus 110 of this type. However, the structures and operations of other types are same with those of this type.

The user inputs his/her fingerprint or signature into an input unit 10. The authentication input apparatus 110 automatically judges whether authentication information being input is the fingerprint or the signature. A warning message is indicated on the display 30 when authentication information other than the fingerprint and the signature is input. The message is, for example, “Please input your fingerprint or signature.”

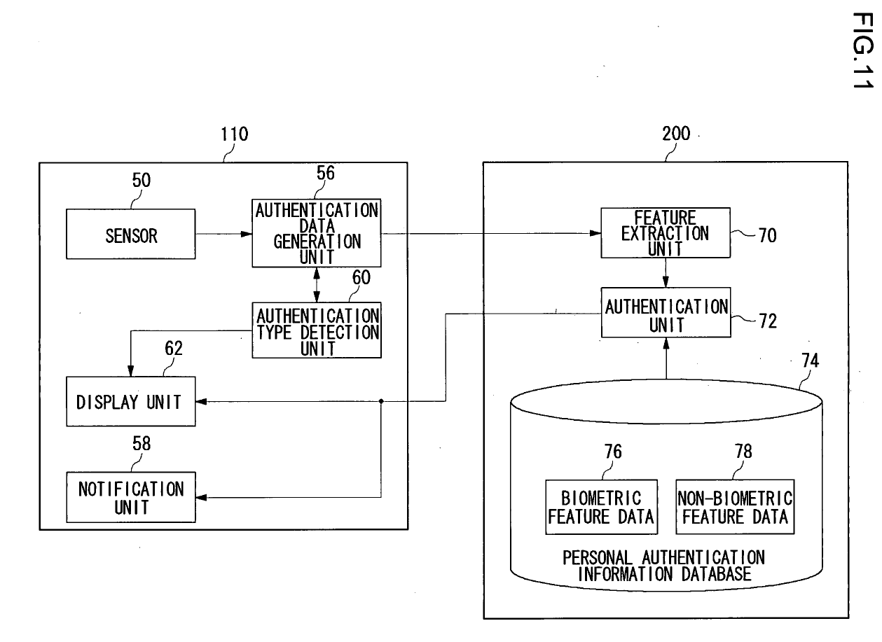

FIG. 11 shows the structure of the authentication system according to the second embodiment of the present invention. The authentication system comprises the authentication input apparatus 100 and an authentication processing apparatus 200. The authentication input apparatus 110 comprises a sensor 50, an authentication data generation unit 56, an authentication type detection unit 60, a display unit 62 and a notification unit 58. The structure and operation of the authentication processing apparatus 200 according to the second embodiment of the present invention are same as those of the authentication processing apparatus 200 of the first embodiment shown in FIG. 8.

The authentication data generation unit 56 processes signals obtained by the sensor 50 and generates authentication data. Thereafter, the authentication data generation unit 56 transmits the authentication data to the authentication type detection unit 60. The authentication type detection unit 60 analyzes the authentication data and detects the type thereof among types of authentication information precedently assumed to be utilized in the authentication. A message for instructing the user to input the predetermined type of authentication information is indicated on the display unit 62 when the authentication type detection unit 60 can not find the type of authentication information being inputted among the precedently assumed types.

The authentication data generation unit 56 provides the authentication data to the authentication processing apparatus 200 after adding thereto identification information indicating the type of authentication information determined by the authentication type detection unit 60. The notification unit 58 receives the result of the authentication from the authentication processing unit 200 and presents it to the user. The result of the authentication by the authentication processing apparatus 200 may be indicated in the display unit 62.

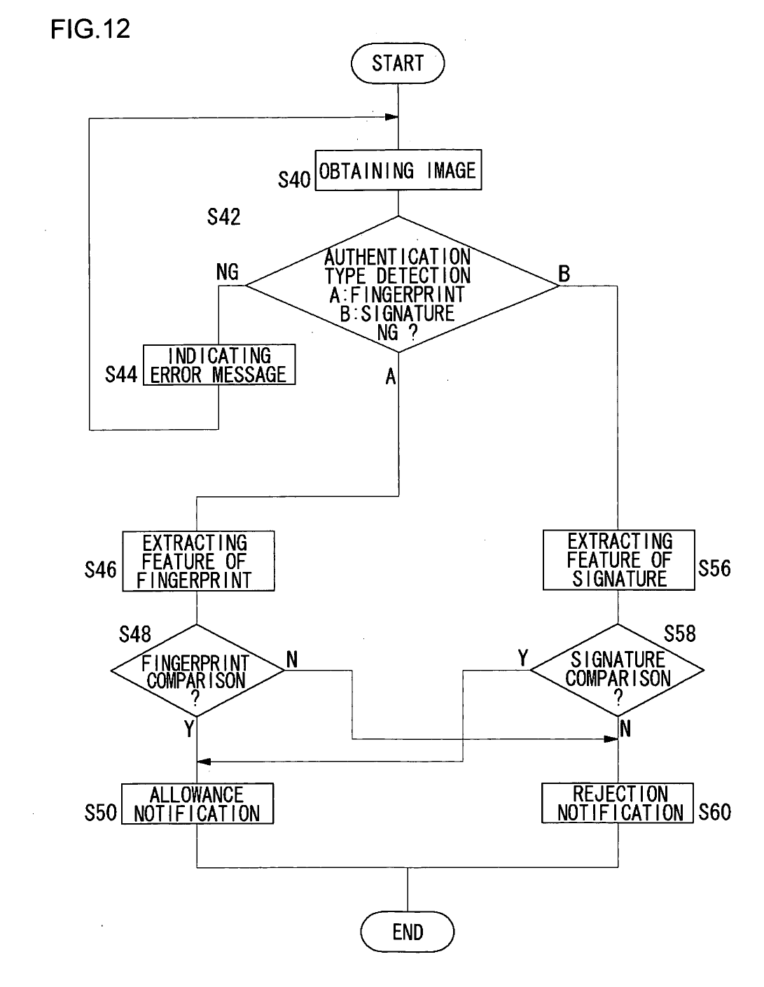

FIG. 12 is a flowchart showing the authentication procedure of the authentication system according to the second embodiment. Hereunder the description will be made on the authentication system having the authentication input apparatus 110 shown in FIG. 10. The sensor 50 of the authentication input apparatus 110 obtains image of the object of the authentication presented by the user (S40). The authentication type detection unit 60 determines whether the obtained image is a fingerprint image or a signature (S42). When the image of the object is detected to be neither a fingerprint nor a signature (NG in S42), the display unit 62 indicates an error message for instructing user to input his/her fingerprint or signature (S44).

When the authentication type detection unit 60 detects that the image inputted for the authentication is the fingerprint image (A in S42), the feature extraction unit 70 carries out image processing suitable for fingerprint images on the image provided from the authentication data generation unit 56 and extracts the feature of the fingerprint (S46). The procedure of comparing the inputted fingerprint to fingerprints of registered users carried out by the authentication unit 72 (S48) and issuing an allowance notification or rejection notification to the user (S50) and S60) are respectively same with S18, S20 and S30 in FIG. 9. The notifications may be indicated to the user by the display unit 62.

When the authentication type detection unit 60 detects that the image inputted for the authentication is the signature image (B in S42), the feature extraction unit 70 carries out image processing suitable for signature images on the image provided from the authentication data generation unit 56 and extracts the feature of the signature (S56). The image processing suitable for signature images is, for example, edge extraction processing, edge enhancement processing or the like. The authentication unit 72 carries out retrieval on biometric feature data 76 of registered users, which are stored in a personal authentication information database 74. The authentication unit 72 then compares the feature in the signature of the user extracted by the feature extraction unit 70 with the features in the signatures of the registered users for examining if there is a signature having the feature identical with that of the user in the biometric feature data 76 (S58). When it is determined that the signature of the user is the signature of one of the registered users (Y in S58), the notification unit 58 presents the allowance notification to the user (S50). When there is no signature identical with the user's signature found among the signatures of the registered users (N in S58), the notification unit 58 presents a rejection notification to the user (S30). These notifications may be indicated by the display unit 62.

The authentication system according to the present embodiment does not need to be provided with buttons or the like for a user to selectively specify the type of the authentication information since the type of the authentication information being inputted to the single input device is automatically detected. Accordingly, the structure of the system can be simplified and user convenience can also be enhanced. Moreover, the system can require a user to input authentication information of one of the predetermined types by indicating a warning message in the display unit, when the user inputs authentication information of which the type is not included in the predetermined types.

Although the present invention has been described by way of exemplary embodiments, it should be understood that many changes and substitutions may further be made by those skilled in the art without departing from the scope of the present invention which is defined by the appended claims.

In the embodiments described above, description is made on the combined type authentications based on the combination of two kinds of biometric data and of biometric data and non-biometric data. However, three types of authentication information may naturally be utilized in the authentication or non-biometric data of two or more kinds may be utilized therein. A retina, vein or voiceprint may also be utilized as biometric data for identifying a person. For example, in a case that the system utilizes voiceprint, a user is requested by the system to pronounce a password. Thereby, a combined type authentication based both on voiceprint authentication and fingerprint authentication can be realized. The gesture of a user can be utilized as one type of biometric data for authenticating the user. Movement or behavior of a person, such as his/her manner of walking, can also be utilized for the authentication. Such feature in a person's behavior can also be utilized as biometric data, in addition to the bodily features.

In the first embodiment, the authentication information is inputted by the user after the user presses the buttons for selecting the type of authentication information. However, the type of the authentication information may be specified after inputting the authentication information. The order of kinds of authentication information to be inputted may precedently be defined. As a user has to merely input plural kinds of authentication information in accordance with that order, the selection buttons for the authentication information can be omitted. In this case, a display unit may be provided for instructing a user the kinds of authentication information one after another in accordance with the order.

1. An authentication apparatus, comprising:
a single input device to which biometric data are inputted as information for authentication; and
a detection unit which detects a type of the information inputted to the single input device among precedently assumed two or more types,
wherein the biometric data of two or more types are sequentially inputted to the single input device.

2. An authentication apparatus according to claim 1, further comprising a display unit which issues warning when the detection unit detects that the type of the inputted information for the authentication is not included in the precedently assumed two or more types.

3. An authentication apparatus according to claim 1, further comprising an authentication processing unit which carries out the authentication after selecting feature extraction processing suitable for the type of the inputted information for the authentication, the type being detected by the detection unit.

4. An authentication apparatus according to claim 2, further comprising an authentication processing unit which carries out the authentication after selecting feature extraction processing suitable for the type of the inputted information for the authentication, the type being detected by the detection unit.

5. An authentication apparatus, comprising a single input device to which biometric data and non-biometric data are inputted as information for authentication, wherein the biometric data and the non-biometric data are sequentially inputted to the single input device.

6. An authentication apparatus according to claim 5, further comprising an authentication type selection unit for selectively specifying a type of the information for the authentication, wherein the type of the information for the authentication to be inputted is specified by the authentication type selection unit when the information for the authentication is inputted to the single input device.

7. An authentication apparatus according to claim 5, further comprising a detection unit which detects a type of the information for the authentication inputted to the single input device among precedently assumed two or more types.

8. An authentication apparatus according to claim 7, further comprising a display unit which issues warning when the detection unit detects that the type of the inputted information for the authentication is not included in the precedently assumed two or more types.

9. An authentication apparatus according to claim 6, further comprising an authentication processing unit which carries out the authentication after selecting feature extraction processing suitable for the type of the inputted information for the authentication, the type being specified by the authentication type selection unit.

10. An authentication apparatus according to claim 7, further comprising an authentication processing unit which carries out the authentication after selecting feature extraction processing suitable for the type of the inputted information for the authentication, the type being detected by the detection unit.

11. An authentication apparatus according to claim 8, further comprising an authentication processing unit which carries out the authentication after selecting feature extraction processing suitable for the type of the inputted information for the authentication, the type being detected by the detection unit.

12. An authentication apparatus, comprising a single input device of an input-by-touch type to which biometric data and non-biometric data are inputted as information for authentication, wherein the biometric data and the non-biometric data are sequentially inputted to the single input device.

13. An authentication apparatus according to claim 12, further comprising an authentication type selection unit for selectively specifying a type of the information for the authentication, wherein the type of the information for the authentication to be inputted is specified by the authentication type selection unit when the information for the authentication is inputted to the single input device of the input-by-touch type.

14. An authentication apparatus according to claim 12, further comprising a detection unit which detects a type of the information for the authentication inputted to the single input device of the input-by-touch type among precedently assumed two or more types.

15. An authentication apparatus according to claim 14, further comprising a display unit which issues warning when the detection unit detects that the type of the inputted information for the authentication is not included in the precedently assumed two or more types.

16. An authentication apparatus according to claim 13, further comprising an authentication processing unit which carries out the authentication after selecting feature extraction processing suitable for the type of the inputted information for the authentication, the type being specified by the authentication type selection unit.

17. An authentication apparatus according to claim 14, further comprising an authentication processing unit which carries out the authentication after selecting feature extraction processing suitable for the type of the inputted information for the authentication, the type being detected by the detection unit.

18. An authentication apparatus according to claim 15, further comprising an authentication processing unit which carries out the authentication after selecting feature extraction processing suitable for the type of the inputted information for the authentication, the type being detected by the detection unit.

19. An authentication method, comprising:
receiving sequential input of information for authentication of two or more types to a single input device of an input-by-touch type; and
receiving from a user information specifying a type of the information for the authentication, when the information for the authentication is inputted.

20. An authentication method, comprising:
receiving sequential input of information for authentication of two or more types to a single input device of an input-by-touch type; and
detecting a type of the information for the authentication among precedently assumed two or more types.
